(19) United States
(12) Patent Application Publication
(10) Pub. No.: US 2026/0230696 A1
(43) Pub. Date: Aug. 6, 2026

(54) INFORMATION PROCESSING DEVICE, INFORMATION PROCESSING METHOD, AND COMPUTER-READABLE MEDIUM

(71) Applicant: NEC Corporation, Tokyo (JP)

(72) Inventors: Yasuhiko OCHIAI, Tokyo (JP); Keisuke INOUE, Tokyo (JP)

(73) Assignee: NEC Corporation, Tokyo (JP)

(21) Appl. No.: 19/152,125

(22) PCT Filed: Feb. 9, 2023
(86) PCT No.: PCT/JP2023/004325

§ 371 Date: Jul. 30, 2025

(51) Int. Cl. H04N 23/61; G06V 10/56; G06V 20/54; H04N 7/18; H04N 23/60

(52) U.S. Cl. CPC H04N 23/61; G06V 10/56; G06V 20/54; H04N 7/18; H04N 23/64; G06V 2201/08

(57) ABSTRACT

Provided is an information processing device having: an acquisition unit that acquires information indicating traffic conditions of a road where an imaging device is positioned, said imaging device imaging an image for detecting a moving body; and a control unit that controls the value of a parameter relating to the imaging of the imaging device, in accordance with the information indicating the traffic conditions that was acquired by the acquisition unit.

### TECHNICAL FIELD

The present disclosure relates to an information processing device, an information processing method, and a non-transitory computer-readable medium storing a program.

### BACKGROUND ART

PTL 1 discloses a technique in which an image on a road is imaged by a camera installed on a road side, and a vehicle traveling on the road is detected from the imaged image by image processing or the like. In addition, PTL 2 discloses a technique of photographing an image in a state in which a focal length or a diaphragm is appropriately driven in order to photograph an illegal vehicle traveling ignoring a red light or an illegal vehicle traveling exceeding a speed limit at an appropriate exposure.

### CITATION LIST

### Patent Literature

PTL 1: JP 2012-198680 A
PTL 2: JP H07-160989 A

### SUMMARY OF INVENTION

### Technical Problem

However, in the techniques described in PTLs 1 and 2, for example, consideration is not given to appropriately performing individual setting for each photographing device installed on the roadside.

In view of the above-described problems, an object of the present disclosure is to provide a technique capable of appropriately performing individual setting with respect to each photographing device installed on a roadside.

### Solution to Problem

According to a first aspect of the present disclosure, there is provided an information processing device including an acquisition unit for acquiring information indicating a traffic condition of a road on which a photographing device for photographing an image for detecting a moving body is installed, and a control unit for controlling a value of a parameter related to photographing of the photographing device according to the information indicating the traffic condition acquired by the acquisition unit.

Furthermore, according to a second aspect of the present disclosure, there is provided an information processing method including: acquiring information indicating a traffic condition of a road on which a photographing device for photographing an image for detecting a moving body is installed, and controlling a value of a parameter related to photographing of the photographing device according to the traffic condition.

In addition, according to a third aspect of the present disclosure, there is provided a non-transitory computer-readable medium stored with a program for causing a computer to execute processes of: acquiring information indicating a traffic condition of a road on which a photographing device for photographing an image for detecting a moving body is installed, and controlling a value of a parameter related to photographing of the photographing device according to the traffic condition.

### Advantageous Effects of Invention

According to one aspect, individual setting can be appropriately performed with respect to each photographing device installed on the roadside.

### BRIEF DESCRIPTION OF DRAWINGS

FIG. 1 is a diagram illustrating a configuration example of an information processing system according to an example embodiment.

FIG. 2 is a diagram illustrating a hardware configuration example of an information processing device, a computer of a vehicle, and a computer of a terminal according to the example embodiment.

FIG. 3 is a diagram illustrating an example of a configuration of an information processing device according to an example embodiment.

FIG. 4 is a sequence diagram illustrating an example of a process of the information processing system according to an example embodiment.

FIG. 5 is a diagram illustrating an example of information recorded in a parameter setting table according to the example embodiment.

### EXAMPLE EMBODIMENT

The principles of the present disclosure will be described with reference to several exemplary example embodiments. It is to be understood that the example embodiments have been described for purposes of illustration only and will aid those skilled in the art in understanding and carrying out the present disclosure without suggesting limitations on the scope of the present disclosure. The disclosure described in the present specification is implemented in various methods other than those described below.

In the following description and claims, unless defined otherwise, all technical and scientific terms used in the present specification have the same meaning as commonly understood by those skilled in the art of the technical field to which the present disclosure belongs.

Hereinafter, example embodiments of the present invention will be described with reference to the drawings.

### System Configuration

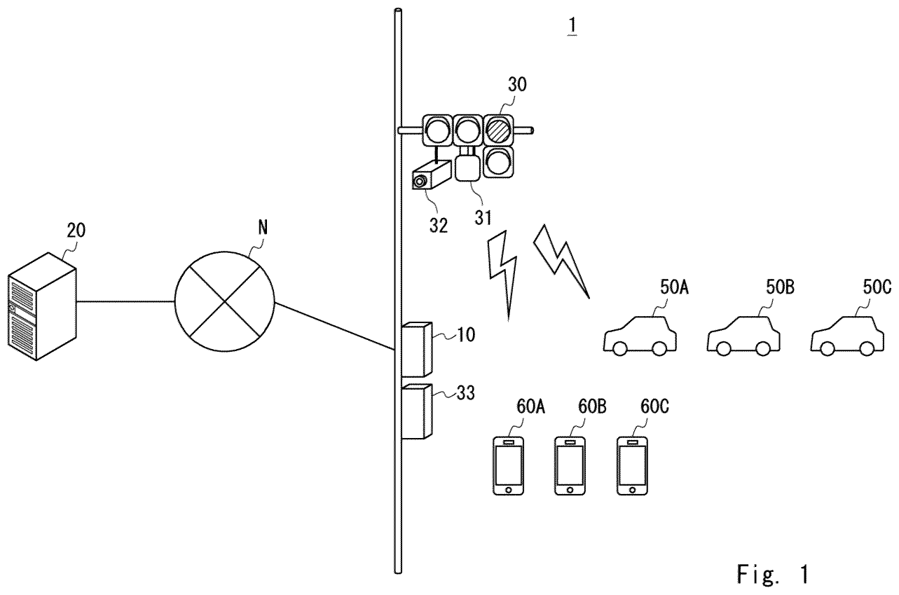

FIG. 1 is a diagram illustrating a configuration example of an information processing system 1 according to the example embodiment. In FIG. 1, the information processing system 1 includes a monitoring server 20, a traffic signal 30, a traffic light base station 31, a photographing device 32, signal control device 33, and information processing device 10. The information processing system 1 also includes a vehicle 50A, a vehicle 50B, and a vehicle 50C (hereinafter, simply referred to as “vehicles 50” in a case where there is no need to distinguish among them). Furthermore, the information processing system 1 includes a terminal 60A, a terminal 60B, a terminal 60C, . . . (hereinafter simply referred to as “terminal 60” in a case where there is no need to distinguish). The number of the monitoring server 20, the traffic signal 30, the traffic light base station 31, a photographing device 32, the signal control device 33, the information processing device 10, the vehicle 50, the terminal 60, and the like is not limited to the example of FIG. 1.

The monitoring server 20 and the information processing device 10 are connected in such a way as to be able to communicate via a communication line N such as the Internet, a wireless local area network (LAN), or a mobile phone network.

The traffic signal 30, the traffic light base station 31, the photographing device 32, the signal control device 33, and the information processing device 10 may be connected in such a way as to be able to communicate by various signal cables or wireless communication.

In the example of FIG. 1, the information processing device 10 is attached to a pole (signal pole) to which the traffic signal 30 is attached, but the technology of the present disclosure is not limited thereto. For example, the information processing device 10 may be attached to a pole (for example, a pole to which a road sign or the like is attached, a street light, a utility pole, or the like) to which the traffic signal 30 is not attached. Furthermore, the information processing device 10 may be, for example, an edge server provided between the traffic light base station 31 and a cloud side device (e.g., monitoring server 20). Furthermore, the information processing device 10 may be, for example, a cloud side server.

The traffic signal 30 is, for example, a traffic signal that is installed on a signal pole of an intersection or the like of a road and that controls traffic between vehicles 50 and pedestrians by displaying green, yellow, red, arrow, and the like. The traffic signal 30 may include a traffic light for vehicles and a traffic light for pedestrians.

The traffic light base station 31 is a base station installed on a signal pole. It should be noted that, the term “base station” (BS) used in the present disclosure refers to a device that can provide or host a cell or coverage in which the vehicle 50 or the terminal 60 can wirelessly communicate. Examples of the traffic light base station 31 include a gNB (NR Node B), a Node B (NodeB or NB), an Evolved Node B (eNodeB or eNB), and the like. Furthermore, examples of the traffic light base station 31 include a remote radio unit (RRU), a radio head (RH), a remote radio head (RRH), a low power node (e.g., femto node, pico node), and the like.

The wireless communication described in the present disclosure may conform to standards such as a 5th generation mobile communications system (5G, New Radio: NR), a 4th generation mobile communication system (4G), and a 3rd generation mobile communication system (3G). 4G may include, for example, long term evolution (LTE) advanced, WiMAX2, and LTE. Furthermore, the wireless communication described in the present disclosure may conform to standards such as a wideband code division multiple access (W-CDMA), a code division multiple access (CDMA), a global system for mobile (GSM), and a wireless local area network (LAN). The wireless communication of the present disclosure may also be performed in accordance with any generation of wireless communication protocols now known or developed in the future.

The photographing device 32 is a photographing device that is installed on a signal pole and measures various types of information related to a road. The photographing device 32 may be, for example, a sensor for photographing an image (two-dimensional or three-dimensional data), such as a camera, Light Detection and Ranging Laser Imaging Detection and Ranging (LiDAR), or radio detection and ranging (RADAR). The photographing device 32 photographs an image with a value of a parameter designated by the information processing device 10, and transmits the photographed image to the information processing device 10.

The information processing device 10 sets a value of a parameter associated to a traffic condition of a road or the like in the photographing device 32. Furthermore, the information processing device 10 may generate information (traffic information) regarding traffic around the traffic signal 30 based on, for example, information acquired from the photographing device 32, the signal control device 33, and the like. Then, the information processing device 10 may transmit (provide, notify) the generated traffic information to external devices such as the vehicle 50, the terminal 60, and the monitoring server 20 via the traffic light base station 31.

The vehicle 50 is a vehicle that travels on a road where the traffic signal 30 is installed. The vehicle 50 performs wireless communication via the traffic light base station 31 by a wireless communication device mounted in the vehicle 50. Examples of the vehicle 50 include, but are not limited to, an automobile, a motorcycle, a motorized bicycle, and a bicycle.

The terminal 60 is a terminal that is carried by a user such as a pedestrian and performs wireless communication via the traffic light base station 31. Examples of the terminal 60 include, but are not limited to, a smartphone, user equipment (UE), a mobile phone, a cellular phone, a personal digital assistant (PDA), a portable computer, a game device, a music storage and music playback device, a wearable device, and the like.

The monitoring server 20 monitors the traffic condition and the like based on the information received from the information processing device 10. The monitoring server 20 may be a server operated by, for example, a public institution. The monitoring server 20 may analyze an accident situation such as a pattern (type) of a traffic accident based on the traffic information provided from the information processing device 10. The information generated by the monitoring server 20 may be provided to, for example, the police, an insurance company, or the like.

The signal control device 33 is installed on a signal pole and controls the traffic signal 30. The signal control device 33 controls display of red, green, yellow, or the like of a signal of the traffic signal 30 based on, for example, a traffic condition detected based on an image of the photographing device 32 or the like, an instruction from a center that manages traffic, preset data, or the like.

### Hardware Configuration

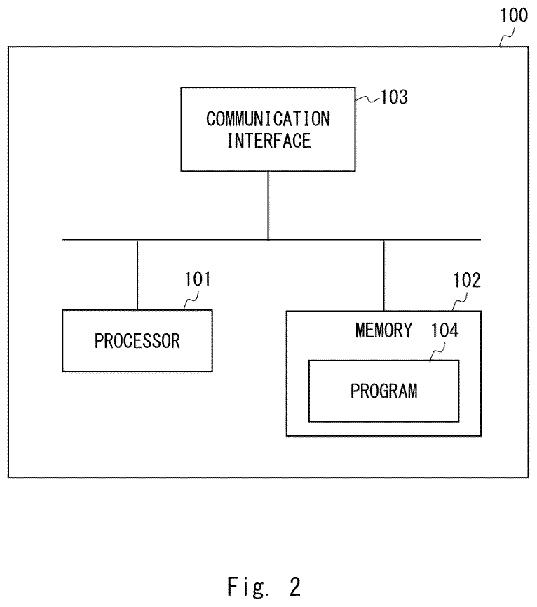

FIG. 2 is a diagram illustrating a hardware configuration example of the information processing device 10, the monitoring server 20, a computer of the vehicle 50, and a computer of the terminal 60 according to the example embodiment. Hereinafter, the information processing device 10 will be described as an example. Hardware configurations of the monitoring server 20, the computer of the vehicle 50, and the computer of the terminal 60 may be similar to the hardware configuration of the information processing device 10 in FIG. 2.

In the example of FIG. 2, the information processing device 10 (computer 100) includes a processor 101, a memory 102, and a communication interface 103. These units may be connected by a bus or the like. The memory 102 stores at least a part of a program 104. The communication interface 103 includes an interface necessary for communication with other network elements.

When the program 104 is executed by the processor 101, the memory 102, and the like in cooperation with each other, at least a part of the process of the example embodiment of the present disclosure is performed by the computer 100. The memory 102 may be of any type suitable for a local technology network. The memory 102 may be a non-transitory computer-readable storage medium, as a non-limiting example. In addition, the memory 102 may also be implemented using any suitable data storage technique such as a semiconductor based memory device, a magnetic memory device and system, an optical memory device and system, a fixed memory, or a removable memory. Although only one memory 102 is illustrated in the computer 100, there may be several physically different memory modules in the computer 100. The processor 101 may be of any type. The processor 101 may include one or more of a general purpose computer, a dedicated computer, a microprocessor, a digital signal processor (DSP), and a processor based on a multi-core processor architecture as a non-limiting example. The computer 100 may have a plurality of processors, such as an application specific integrated circuit chip that is temporally dependent on a clock that synchronizes the main processor.

Example embodiments of the present disclosure may be implemented in hardware or dedicated circuitry, software, logic, or any combination thereof. Some aspects may be implemented in hardware, while other aspects may be implemented in firmware or software that may be executed by a controller, microprocessor or other computing device.

The present disclosure also provides at least one computer program product tangibly stored on a non-transitory computer-readable storage medium. The computer program product includes computer-executable instructions, such as those included in a program module, and is executed on a device on a target real or virtual processor to perform the processes or methods of the present disclosure. The program module includes routines, programs, libraries, objects, classes, components, data structures, and the like that execute particular tasks or implement particular abstract data types. Functions of the program module may be combined or divided between the program modules as desired in various example embodiments. A machine-executable instruction of the program module can be executed in a local or distributed device. In a distributed device, program modules can be located on both local and remote storage media.

Program code for executing the methods of the present disclosure may be written in any combination of one or more programming languages. These program codes are provided to a processor or controller of a general purpose computer, a dedicated computer, or other programmable data processing devices. When the program code is executed by the processor or controller, the functions/operations in the flowcharts and/or the implemented block diagrams are performed. The program code is executed entirely on the machine, partly on the machine, as a stand-alone software package, partly on the machine, partly on a remote machine, or entirely on the remote machine or the server.

The program includes a group of instructions (or software code) for causing the computer to perform one or more functions described in the example embodiments when the program is loaded into the computer. The program may be stored in a non-transitory computer-readable medium or a tangible storage medium. As an example and not by way of limitation, the computer-readable medium or the tangible storage medium includes a random access memory (RAM), a read only memory (ROM), a flash memory, a solid-state drive (SSD) or any other memory technology, a CD-ROM, a digital versatile disc (DVD), a Blu-ray (registered trademark) disc or any other optical disk storage, a magnetic cassette, a magnetic tape, a magnetic disk storage, and any other magnetic storage device. The program may be transmitted through a transitory computer-readable medium or a communication medium. As an example and not by way of limitation, a transitory computer-readable or communication medium includes electrical, optical, acoustic, or other forms of propagated signals.

### Configuration

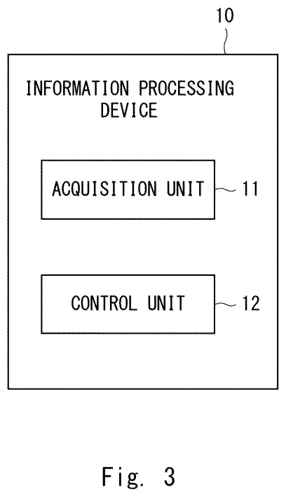

A configuration of the information processing device 10 according to an example embodiment will be described with reference to FIG. 3. FIG. 3 is a diagram illustrating an example of the configuration of the information processing device 10 according to the example embodiment. The information processing device 10 includes an acquisition unit 11 and a control unit 12. These units may be implemented by cooperation of one or more programs installed in the information processing device 10 and hardware such as the processor 101 and the memory 102 of the information processing device 10.

The acquisition unit 11 acquires information indicating a traffic condition of a road on which the photographing device 32 that photographs an image for detecting a moving body such as the vehicle 50 or a pedestrian is installed. The control unit 12 controls a value of a parameter regarding photographing of the photographing device 32 based on the information acquired by the acquisition unit 11.

### Process

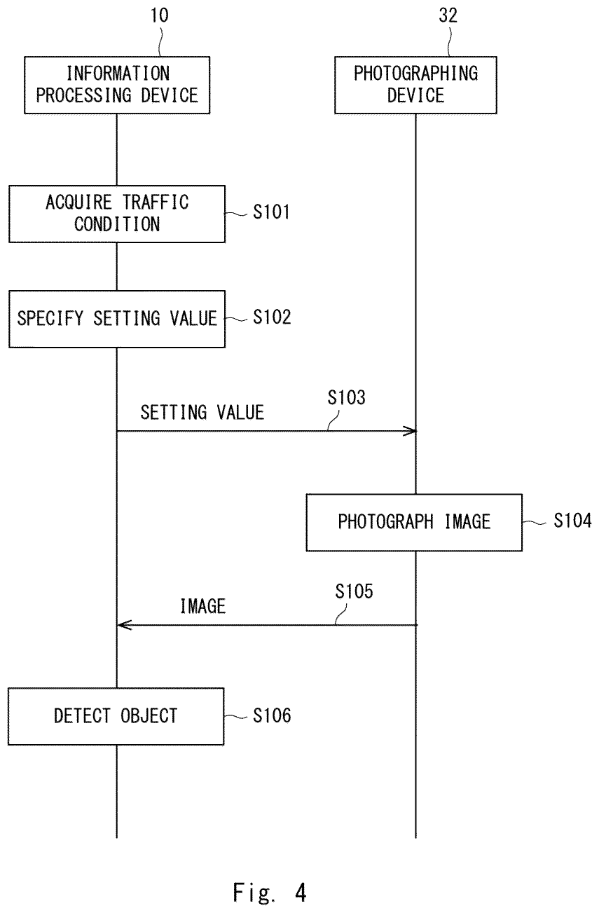

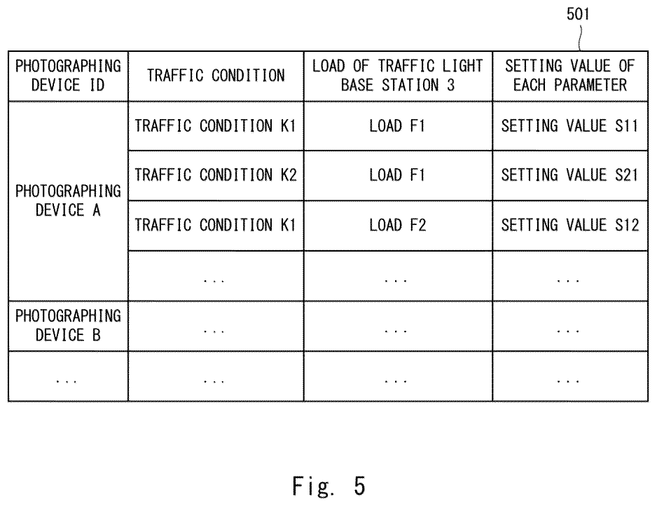

Next, an example of a process in the information processing system 1 according to the example embodiment will be described with reference to FIGS. 4 and 5. FIG. 4 is a sequence diagram illustrating an example of the process in the information processing system 1 according to the example embodiment. FIG. 5 is a diagram illustrating an example of information recorded in a parameter setting table 501 according to the example embodiment.

The processes from step S101 to step S103 may be executed, for example, at a timing such as regularly. Furthermore, the processes from step S101 to step S103 may be executed, for example, only when the traffic condition is changed.

Furthermore, the processes from step S104 to step S106 may be executed, for example, constantly.

In step S101, the acquisition unit 11 of the information processing device 10 acquires information indicating traffic conditions of roads around a range photographed by the photographing device 32. Here, for example, the acquisition unit 11 may determine (estimate, infer) the traffic condition by artificial intelligence (AI) using deep learning or the like based on the image photographed by the photographing device 32. Furthermore, the acquisition unit 11 may determine the traffic condition based on, for example, various sensors installed on a road or the like. In addition, the acquisition unit 11 may receive, for example, information indicating a traffic condition from the monitoring server 20.

The information indicating the traffic condition may include the number of vehicles 50 traveling on the road. Thus, for example, at relatively dark nighttime or the like, the parameter of the photographing device 32 can be appropriately determined according to the number of vehicles 50 that illuminate the road with headlights or the like. In addition, the information indicating the traffic condition may include the type of the vehicle 50 traveling on the road. As a result, for example, the parameter of the photographing device 32 can be appropriately determined according to the irradiation range of the headlight or the like for each type of vehicle. Furthermore, for example, in a case where a specific type of vehicle 50 is relatively likely to cause an accident, parameter of the photographing device 32 associated to the vehicle 50 can be determined.

In addition, the information indicating the traffic condition may include the traveling speed of each vehicle 50 traveling on the road. Thus, for example, the parameter of the photographing device 32 associated to the traveling speed of the vehicle 50 can be determined.

In addition, the information indicating the traffic condition may include the color of each vehicle 50 traveling on the road. Thus, for example, the parameter of the photographing device 32 associated to the color of the vehicle 50 can be determined.

In addition, the information indicating the traffic condition may include a lighting state of a signal of the traffic signal 30 on the road. The lighting state of the signal may be, for example, a state of green, yellow, red, and arrow display on the traffic signal 30. As a result, for example, the parameter of the photographing device 32 associated to the color of the signal of the traffic signal 30 on the road can be determined. For example, in a case where the lighting state of the signal is red, the control unit 12 may slow the shutter speed since the moving body such as the vehicle 50 and the pedestrian stops. Furthermore, in a case where the lighting state of the signal is green, the control unit 12 may fasten the shutter speed since the moving body such as the vehicle 50 and the pedestrian moves.

Subsequently, the control unit 12 of the information processing device 10 specifies a value (setting value) of a parameter related to photographing of the photographing device 32 according to the traffic condition of the road (step S102). The parameter related to photographing may include, for example, at least one of a diaphragm value, a shutter speed, an ISO sensitivity, a sharpness, and a contrast. Here, for example, in a case where the number of vehicles 50 traveling on the road is equal to or less than a threshold value at a relatively dark nighttime or the like, the control unit 12 may increase the exposure (amount of light taken into the camera) by adjusting at least one setting value of the diaphragm value (F value), the shutter speed, and the International Organization for Standardization (ISO) sensitivity. This is because, when the number of vehicles 50 traveling on the road is equal to or less than the threshold value, the degree to which the subject is illuminated by the headlight or the like of each vehicle 50 is considered to be relatively low. The ISO sensitivity may be, for example, a reference value for amplifying a signal in an image sensor of a digital camera.

Furthermore, for example, in a case where the number of vehicles 50 traveling on the road is equal to or greater than a threshold value, the control unit 12 may increase the setting value of the diaphragm value. As a result, since the range in which focus is achieved becomes wider, there is a possibility that the detection accuracy of the subject in the region near the end portion of the image can be increased. The larger the diaphragm value, the smaller the amount of light to be taken in, and the wider the range in focus.

Furthermore, for example, in a case where a specific type of vehicle 50 (e.g., a dump car, a vehicle for the elderly, and the like) exists, the control unit 12 may increase (enhance) a setting value of sharpness (contour enhancement). As a result, for example, there is a possibility that the detection accuracy of a type of vehicle that is relatively likely to cause an accident or has relatively great damage when an accident occurs can be increased.

Furthermore, the control unit 12 may increase the setting value of the shutter speed based on, for example, at least one of a representative value (mean, mode, or median) and a maximum value of the traveling speed of each vehicle 50 traveling on the road. As a result, for example, blurring is reduced, and hence there is a possibility that the detection accuracy of the subject can be increased.

Furthermore, for example, in a case where each vehicle 50 traveling on the road includes a vehicle 50 whose color is a specific color (e.g., gray), the control unit 12 may increase the setting value of the contrast. As a result, for example, there is a possibility that the detection accuracy of the subject having a similar color as the background can be increased.

Furthermore, the control unit 12 may determine the setting value of the shutter speed, for example, based on the color of the signal of the traffic signal 30 of the road. In this case, for example, in the case of the green light, since it is considered that the vehicle 50 is traveling, the control unit 12 may increase the setting value of the shutter speed. As a result, for example, blurring is reduced, and hence there is a possibility that the detection accuracy of the subject can be increased.

### Example of Determining According to Load of Traffic Light Base Station 31

Furthermore, the control unit 12 may specify the value of the parameter related to the photographing of the photographing device 32 according to, for example, the traffic condition and the load of the traffic light base station 31 installed in association with the photographing device 32. In this case, the load of the traffic light base station 31 may include at least one of the number of user terminals (e.g., the vehicle 50 and the terminal 60) located in the traffic light base station 31, the data amount of uplink communication to the traffic light base station 31, and the data amount of downlink communication from the traffic light base station 31. The user terminal being located in the traffic light base station 31 means, for example, that the user terminal registers a position in the traffic light base station 31 in order to perform uplink or downlink communication via the traffic light base station 31.

For example, it is assumed that the information processing device 10 is multi-access edge computing (MEC) or the like, and in order to perform various types of processing caused by wireless communication, the load of the processing of the information processing device 10 becomes higher the higher the load of the traffic light base station 31. Furthermore, it is assumed that the object detection process using AI is performed by the information processing device 10. In this case, for example, when the load of the traffic light base station 31 is less than a threshold value, the control unit 12 may perform the object detection using a first learned model.

Then, when the load of the traffic light base station 31 is equal to or greater than the threshold value, the control unit 12 may perform the object detection using a second learned model capable of performing the object detection at a higher speed (lower operation amount) than the first learned model. Then, when the load of the traffic light base station 31 is equal to or greater than the threshold value, the control unit 12 may specify the value of the parameter according to the traffic condition based on a table for the second learned model or the like.

### Example of Determining According to Traffic Condition Of Nearby Road

The control unit 12 may specify the value of the parameter according to the traffic condition of the nearby road. In this case, the acquisition unit 11 may acquire information indicating the traffic condition of the road on which the photographing device 32 is installed and information indicating the traffic condition at the intersection adjacent to the intersection of the road. Then, the control unit 12 may specify the parameter related to photographing by the photographing device 32 according to the traffic condition of the road and the traffic condition at the intersection adjacent to the intersection of the road. As a result, for example, the control unit 12 can set parameters associated to the number of vehicles 50 passing through the intersection in front, the traveling speed, and the like in the photographing device 32 before the vehicle 50 arrives at the road.

The control unit 12 may refer to a parameter setting table 501 of FIG. 5 to specify the setting value of each parameter according to the traffic condition or the like. In the example of FIG. 5, a setting value of each parameter is recorded in the parameter setting table 501 in association with a combination of a photographing ID, the traffic condition, and the load of the traffic light base station 31. The photographing device ID is identification information of the photographing device 32. The traffic condition may be classified (staged, grouped) for every range of value of each item included in the information indicating the traffic condition. In this case, for example, the traffic condition may be divided into three classes of heavy, normal and light according to the number of vehicles 50 traveling on the road. The information in the parameter setting table 501 may be set in advance by an operator (administrator) or the like.

Furthermore, the information of the parameter setting table 501 may be recorded by the control unit 12. In this case, the control unit 12 may detect an object by AI based on each image photographed with each setting value for each parameter for every photographing device 32 and every traffic condition or the like. Then, the control unit 12 may record a setting value group having the highest accuracy of object detection in each image in the parameter setting table 501 in association with the traffic condition or the like. As a result, for example, an appropriate setting value can be determined for every traffic condition or the like according to the angle of view, the background, and the like of the photographing device 32.

For example, the control unit 12 may specify the value of the parameter to be set in the photographing device 32 based on the detection accuracy of the moving body by the image photographed with the first parameter value by the photographing device 32 and the detection accuracy of the moving body by the image photographed with the second parameter value. In this case, for example, the control unit 12 may determine the detection accuracy of the vehicle 50 or the like by the image photographed with the first parameter value by the photographing device 32 when the road is in a specific traffic condition. Then, for example, the control unit 12 may determine the detection accuracy of the vehicle 50 or the like by the image photographed with the second parameter value by the photographing device 32 when the road is in a specific traffic condition. Then, for example, the control unit 12 may specify a parameter value having higher detection accuracy among the first parameter value and the second parameter value as a parameter value to be set in a case of a specific traffic condition. The control unit 12 may use, as the value indicating the detection accuracy, for example, a value of reliability (certainty) calculated as likelihood of the vehicle 50 when the vehicle 50 is detected by deep learning or the like. The control unit 12 is not limited to two of the first parameter value and the second parameter value, and may specify the value of the parameter to be set based on the detection accuracy of the moving body by the image photographed with three or more parameter values.

Subsequently, the control unit 12 of the information processing device 10 causes the photographing device 32 to set the specified value of parameter (step S103). Here, the control unit 12 may transmit a command for setting the value of the parameter to the photographing device 32.

Subsequently, the photographing device 32 photographs an image with the set parameter value (step S104). Then, the photographing device 32 transmits the photographed image to the information processing device 10 (step S105).

Subsequently, the control unit 12 of the information processing device 10 detects a moving body based on the photographed image (step S106). Here, the control unit 12 may detect (estimate, infer) the type or the like of the subject by, for example, AI using deep learning or the like. Then, the control unit 12 may, for example, determine the traffic condition or the like based on the detection result.

### Modified Example

For example, the control unit 12 may control a value of a parameter related to photographing in accordance with information indicating a traffic condition of a road and information indicating at least one of a time zone and weather. In this case, for example, in a case of nighttime, cloudy weather, or rainy weather, and in a case where the number of vehicles traveling on the road is small, the control unit 12 may control the value of the parameter in such a way as to increase the exposure time as the road is dark.

Furthermore, the control unit 12 may control the value of the parameter related to photographing, for example, based on statistics for a predetermined period of the traffic condition of the road. In this case, the control unit 12 may control the value of the parameter based on, for example, a statistical value per unit time of the number of vehicles. The statistical value may be, for example, a maximum value, a minimum value, or a representative value (mean, mode, or median).

Each functional unit (e.g., the control unit 12) of the information processing device 10 may be achieved by, for example, cloud computing including one or more computers. Furthermore, the information processing device 10 and the monitoring server 20 may be configured as an integrated server. Such an information processing device 10 is also included in an example of the “information processing device” of the present disclosure.

The present invention is not limited to the above example embodiments, and can be appropriately changed without departing from the gist.

Some or all of the above-described example embodiments may be described as the following supplementary notes, but are not limited to the following supplementary notes.

### Supplementary Note 1

An information processing device including:
an acquisition unit for acquiring information indicating a traffic condition of a road on which a photographing device for photographing an image for detecting a moving body is installed, and
a control unit for controlling a value of a parameter related to photographing of the photographing device according to the information indicating the traffic condition acquired by the acquisition unit.

### Supplementary Note 2

The information processing device according to supplementary note 1, in which the information indicating the traffic condition includes number of vehicles traveling on the road.

### Supplementary Note 3

The information processing device according to supplementary note 1 or 2, in which the information indicating the traffic condition includes a type of a vehicle traveling on the road.

### Supplementary Note 4

The information processing device according to supplementary note 1 or 2, in which the information indicating the traffic condition includes traveling speed of a vehicle traveling on the road.

### Supplementary Note 5

The information processing device according to supplementary note 1 or 2, in which the information indicating the traffic condition includes a color of a vehicle traveling on the road.

### Supplementary Note 6

The information processing device according to supplementary note 1 or 2, in which the information indicating the traffic condition includes a lighting state of a signal of a traffic signal of the road.

### Supplementary Note 7

The information processing device according to supplementary note 1 or 2, in which
the acquisition unit acquires the information indicating the traffic condition of the road and information indicating a traffic condition at an intersection adjacent to an intersection of the road, and
the control unit controls a parameter related to photographing by the photographing device according to the traffic condition of the road and the traffic condition at the intersection adjacent to the intersection of the road.

### Supplementary Note 8

The information processing device according to supplementary note 1 or 2, in which the control unit specifies a value of the parameter to be set in a case of a specific traffic condition based on a detection accuracy of the moving body by an image photographed with a first parameter value by the photographing device when the road is in the specific traffic condition and a detection accuracy of the moving body by an image photographed with a second parameter value by the photographing device when the road is in the specific traffic condition.

### Supplementary Note 9

The information processing device according to supplementary note 1 or 2, in which the parameter includes at least one of a diaphragm value, a shutter speed, an ISO sensitivity, sharpness, and contrast.

### Supplementary Note 10

The information processing device according to supplementary note 1 or 2, in which the control unit controls a value of the parameter according to the traffic condition and a load of a base station installed in association with the photographing device.

### Supplementary Note 11

The information processing device according to supplementary note 10, in which the load of the base station includes at least one of a number of user terminals located in the base station, a data amount of uplink communication to the base station, and a data amount of downlink communication from the base station.

### Supplementary Note 12

An information processing method including:
acquiring information indicating a traffic condition of a road on which a photographing device for photographing an image for detecting a moving body is installed, and
controlling a value of a parameter related to photographing of the photographing device according to the traffic condition.

### Supplementary Note 13

A non-transitory computer-readable medium stored with a program for causing a computer to execute processes of:
acquiring information indicating a traffic condition of a road on which a photographing device for photographing an image for detecting a moving body is installed, and
controlling a value of a parameter related to photographing of the photographing device according to the traffic condition.

### REFERENCE SIGNS LIST

1 information processing system
10 information processing device
11 acquisition unit
12 control unit
20 monitoring server
30 traffic signal
31 traffic light base station
32 photographing device
33 signal control device
50 vehicle
60 terminal

What is claimed is:

1. An information processing device comprising:
at least one memory configured to store instructions; and
at least one processor configured to execute the instructions to:
acquire information indicating a traffic condition of a road on which a photographing device for photographing an image for detecting a moving body is installed; and
control a value of a parameter related to photographing of the photographing device according to the information indicating the traffic condition.

2. The information processing device according to claim 1, wherein the information indicating the traffic condition includes number of vehicles traveling on the road.

3. The information processing device according to claim 1, wherein the information indicating the traffic condition includes a type of a vehicle traveling on the road.

4. The information processing device according to claim 1, wherein the information indicating the traffic condition includes traveling speed of a vehicle traveling on the road.

5. The information processing device according to claim 1, wherein the information indicating the traffic condition includes a color of a vehicle traveling on the road.

6. The information processing device according to claim 1, wherein the information indicating the traffic condition includes a lighting state of a signal of a traffic signal of the road.

7. The information processing device according to claim 1, wherein the at least one processor configured to execute the instructions to:
acquire the acquisition unit acquires the information indicating the traffic condition of the road and information indicating a traffic condition at an intersection adjacent to an intersection of the road; and
control a parameter related to photographing by the photographing device according to the traffic condition of the road and the traffic condition at the intersection adjacent to the intersection of the road.

8. The information processing device according to claim 1, wherein the at least one processor configured to execute the instructions to specify a value of the parameter to be set in a case of a specific traffic condition based on a detection accuracy of the moving body by an image photographed with a first parameter value by the photographing device when the road is in the specific traffic condition and a detection accuracy of the moving body by an image photographed with a second parameter value by the photographing device when the road is in the specific traffic condition.

9. The information processing device according to claim 1, wherein the parameter includes at least one of a diaphragm value, a shutter speed, an ISO sensitivity, sharpness, and contrast.

10. The information processing device according to claim 1, wherein the at least one processor configured to execute the instructions to control control unit controls-a value of the parameter according to the traffic condition and a load of a base station installed in association with the photographing device.

11. The information processing device according to claim 10, wherein the load of the base station includes at least one of a number of user terminals located in the base station, a data amount of uplink communication to the base station, and a data amount of downlink communication from the base station.

12. An information processing method comprising:
acquiring information indicating a traffic condition of a road on which a photographing device for photographing an image for detecting a moving body is installed; and
controlling a value of a parameter related to photographing of the photographing device according to the traffic condition.

13. A non-transitory computer-readable medium stored with a program for causing a computer to execute processes of:
acquiring information indicating a traffic condition of a road on which a photographing device for photographing an image for detecting a moving body is installed; and
controlling a value of a parameter related to photographing of the photographing device according to the traffic condition.
